(19) United States
(12) Patent Application Publication
(10) Pub. No.: US 2021/0235625 A1
(43) Pub. Date: Aug. 5, 2021

(54) IMPROVEMENTS RELATING TO TOOL HANDLES

(71) Applicant: OAKTHRIFT CORPORATION LTD., HERTFORDSHIRE (GB)

(72) Inventor: JAMES JOHN THORN, ROCHFORD (GB)

(21) Appl. No.: 16/755,783

(22) PCT Filed: Oct. 8, 2018
(86) PCT No.: PCT/GB2018/052869

§ 371 Date: Apr. 13, 2020

(30) Foreign Application Priority Data
Oct. 17, 2017 (GB) 1717041.6

(51) Int. Cl. A01G 3/025; B25G 1/04

(52) U.S. Cl. CPC A01G 3/0251; B25G 1/04

(57) ABSTRACT

A pruning device comprises a pair of cooperating blades that are pivoted together and a pair of rigid elongate handle stems movable to and from each other for a user to operate the cooperating blades. Each handle stem is telescopic, having a first portion and a second portion that is slidably extendable relative to the first portion and the blades. Each handle stem has attached thereto a first grip located adjacent a distal end of its moveable portion and a second grip spaced apart from the first grip and located between the first grip and the blades.

The present invention relates to improvements in tool handles. In particular the present invention relates to improvements in the handles of pruning devices.

Shears, loppers and other pruning devices are widely used for pruning in horticultural and agricultural environments.

Such tools often comprise extendable handles so as to allow a user to work on foliage and branches that would otherwise be out of reach with unextended handles.

The present invention seeks to improve upon the prior art.

According to the present invention there is provided a pruning device comprising:
a pair of cooperating blades that are pivoted together;
a pair of rigid elongate handle stems movable to and from each other for a user to operate the cooperating blades; wherein:
each handle stem is telescopic, having a first portion and a second portion that is slidably extendable relative to the first portion and the blades;
each handle stem has attached thereto a first grip located adjacent a distal end of its moveable portion and a second grip spaced apart from the first grip and located between the first grip and the blades.

Providing first and second grips on the handles of a pruning device a user to select from two different lengths at which to grasp the handles without going to the effort of adjusting a telescoping mechanism. Further, by providing first grips on a moveable telescoping portion the grips may be positioned over a continuous range of distances from the blades.

In some embodiments the second grips are attached to the first portions of the handle stems.

In some embodiments the second grips are attached adjacent distal ends of the first portions of the handle stems.

In some embodiments the second grips are attached to the moveable portions of the handle stems.

In some embodiments the second grips are attached adjacent proximal ends of the moveable portions of the handle stems.

Providing a second pair grips adjacent the proximal end of the slidably moveable portions or adjacent distal ends of the first portions is particularly advantageous as it can mitigate the need for a user to repeatedly alter the handles between fully extended and unextended configurations.

This is because when the handles are extended the second pair grips is roughly at a distance from the blades that the first pair of grips are located when the handles are unextended.

Furthermore, providing a second pair of grips on the slidably moveable portions or on the static portions allows for a user to hold the device in a position that is more balanced and easier to use (in comparison to holding the device with the first pair grips adjacent the distal ends of the handles).

In some embodiments a grip is formed of a moulded material.

In some embodiments a grip is formed of a textured material.

In some embodiments a grip is formed of a plastics or rubber material.

In some embodiments the handle stems are formed of a metal.

In some embodiments the pruning device is a pair of shears, secateurs, or loppers.

In order that the present invention may be more fully understood a specific embodiment will now be described by way of example with reference to the accompanying schematic drawings, of which:

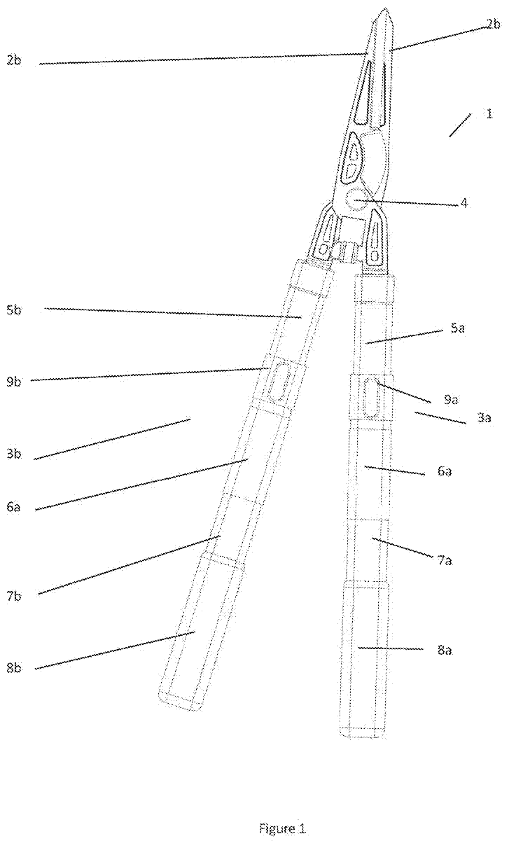

FIG. 1 is a plan view of a first side of a pruning device made in accordance with the present invention with its handles unextended;

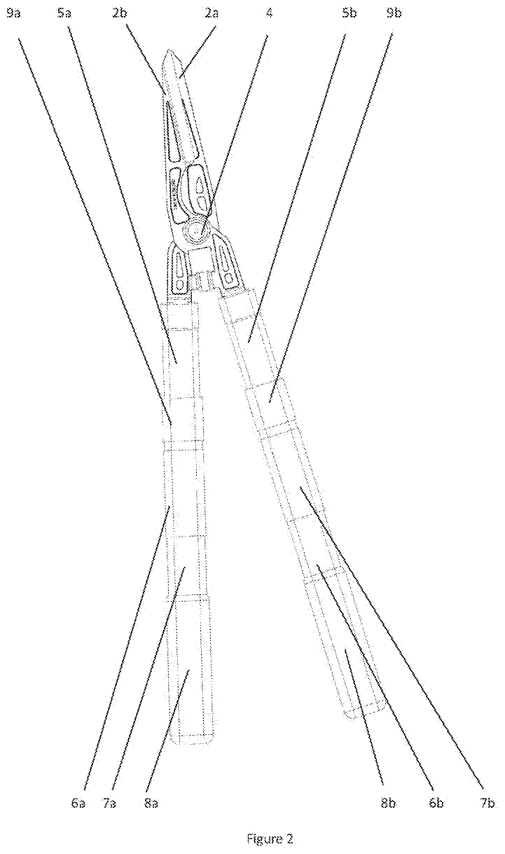

FIG. 2 is a plan view of the second side of the pruning device of FIG. 1;

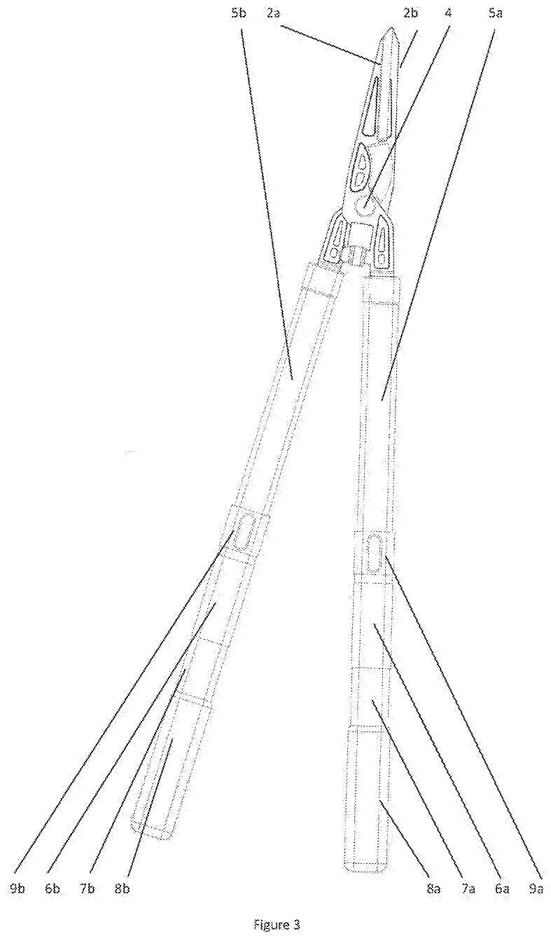

FIG. 3 is a plan view of the first side of the pruning device of FIG. 1 with its handles extended;

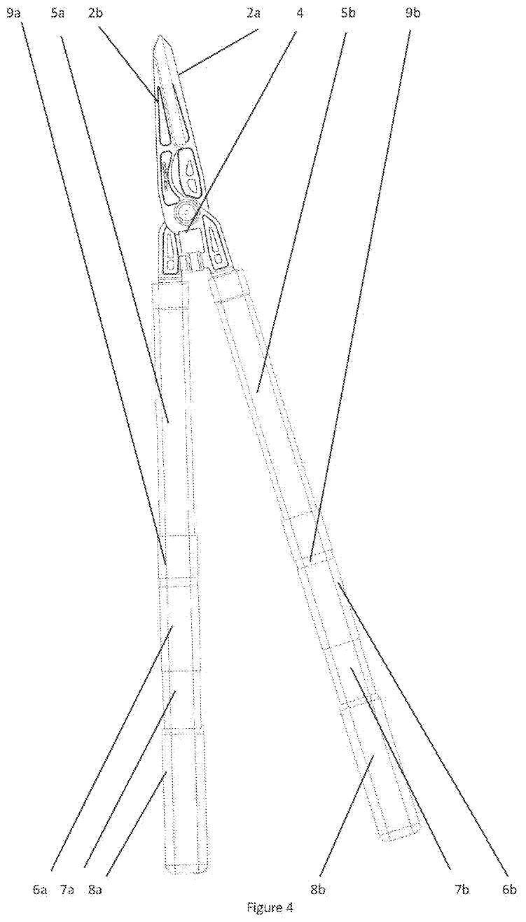

FIG. 4 is a plan view of the second side of the pruning device of FIG. 3.

Referring to the drawings a pruning device 1 comprises a pair of blades 2a, 2b and a pair of handles 3a, 3b.

Blade and handle 2a, 3a are connected to blade and handle 2b, 3b by means of pivot 4.

Handles 3a, 3b are each comprised of a first aluminium handle portions 5a, 5b that are in a substantially fixed position relative to their respective blade portions 2a, 2b and second aluminium handle portions 7a, 7b that are slidably mounted on first portions 5a, 5b.

Each handle 3a, 3b also comprises a lock 9a, 9b adapted to releasably lock second handle portions 7a, 7b in a substantially fixed position relative to the first handle portion 5a, 5b on which it is mounted, thereby allowing a user to maintain handles 3a, 3b at a desired length.

Locks 9a, 9b are located at the proximal ends of second handle portions 7a, 7b.

Located at and adjacent the distal ends of second handle portions 7a, 7b is a first pair of grips 8a, 8b.

Grips 8a, 8b are formed of a moulded plastics material and are adapted for a user to grip handles 3a, 3b so as to operate pruning device 1.

Located adjacent locks 9a, 9b and adjacent the proximal ends of second handle portions 7a, 7b is a second pair of grips 6a, 6b.

Grips 6a, 6b are formed of a moulded plastics material and are adapted for a user to grip handles 3a, 3b so as to operate pruning device 1.

When pruning device 1 is in use a user has a choice between employing first pair of grips 8a, 8b in order to operate pruning device 1 or employing second pair of grips 6, 6b in order to operate pruning device 1.

In most embodiments it is envisaged that a length of a grip is likely to be in the region of 8 cm to 18 cm, or in the region of 10 cm to 16 cm, or in the region of 12 to 14 cm.

In the present application the term ‘grip’ is intended to mean something that is distinct and different from a stem part of a regular handle where a user is not expected to grip the pruning device in use.

In the application the term ‘grip’ is intended to mean a specific grip, something that is intended and suitable for a person to grip a handle in order to employ use of the pruning device. A grip normally has anti-slip properties, owing its shape and/or owing to the material that it is manufactured from.

In most embodiments it is envisaged that for strength stems of a tool handle will be formed of a metal material with the grips attached thereto being formed of a moulded plastics or rubber material.

However, in some embodiments a handle may be formed of a stem of a tool handle may be formed of a non-metallic material such as plastic.

It is envisaged that in most embodiments grips will be formed of a different material to the material used to form the stems of the tool handles. In many embodiments grips may be coloured differently to stems to even more clearly indicate to a user where grips are positioned.

In many embodiments a grip may be ergonomically moulded with contours and/or indentations adapted to be grasped by the fingers and thumb of a user.

Many variations are possible without departing from the scope of the present invention as defined in the appended claims.

1. A pruning device comprising:
a pair of cooperating blades that are pivoted together;
a pair of rigid elongate handle stems movable to and from each other for a user to operate the cooperating blades; wherein:
each handle stem is telescopic, having a first portion and a second portion that is slidably extendable relative to the first portion and the blades;
each handle stem has attached thereto a first grip located adjacent a distal end of its moveable portion and a second grip spaced apart from the first grip and located between the first grip and the blades.

2. The device of claim 1 wherein the second grips are attached to the first portions of the handle stems.

3. The device of claim 1 wherein the second grips are attached adjacent distal ends of the first portions of the handle stems.

4. The device of claim 1 wherein the second grips are attached to the moveable portions of the handle stems.

5. The device of claim 1 wherein the second grips are attached adjacent proximal ends of the moveable portions of the handle stems.

6. The device of claim 1 wherein a grip is formed of a moulded material.

7. The device of claim 1 wherein a grip is formed of a textured material.

8. The device of claim 1 wherein a grip is formed of a plastics or rubber material.

9. The device of claim 1 wherein the handle stems are formed of a metal.

10. The device of claim 1 wherein the pruning device is a pair of shears, secateurs, or loppers.
